(19) United States
(12) Patent Application Publication
(10) Pub. No.: US 2006/0101143 A1
(43) Pub. Date: May 11, 2006

(54) Handling of invitations to group communication sessions

(75) Inventors: Miguel Garcia, Helsinki (FI); Hisham Khartabil, Oslo (NO); Pekka Kuure, Espoo (FI); Jari Mutikainen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/085,053

(22) Filed: Mar. 22, 2005

(30) Foreign Application Priority Data
Nov. 11, 2004 (EP) 04026824.5

(51) Int. Cl. G06F 15/173

(52) U.S. Cl. 709/225

(57) ABSTRACT

A method controls group communication in a communication network. The method includes sending, to a plurality of users, requests to join a group communication session. The method also includes detecting that at least one of the users was not accepting the request to join the group communication. The method also includes subscribing to a status of the at least one of the users not joining the group communication session. The status may be a registration status or a presence status.

### BACKGROUND OF THE INVENTION

1. Field of the Invention

The invention relates to a method for controlling group communication and a group communication server in a communication network.

2. Description of the Related Art

A prior art group communication server is disclosed, for example, in document US2002/0150091. In detail, in this document the group communication server is a call processing server being responsible for a control plane management of group communications.

The present invention relates in particular to an environment that uses SIP (Session Initiation Protocol) to establish sessions between users.

Currently, when a SIP session to a number of invitees is initiated, the SIP conference server sends the invitations (INVITE messages) to all group members. In case that some intended user was not registered to the SIP core network during the original session initiation, the participant will not receive an invitation. In case that the user registers to the SIP core at a later stage, but though during the conference existence, and even though she/he could potentially wish to join the conference, she/he is not informed of the attempt to bring her/him into the conference. Moreover, the SIP core of the non-registered terminal returns a final response, which finalizes the SIP session establishment procedure towards that particular user.

Currently there does not exist a mechanism to late join to a particular session that was invited earlier. Potentially, the user that registers to SIP core late, when a conference still exists, which is also intended for him/her, the subscriber could get knowledge of the existing conference by e.g. subscribing to conference state package.

That is, at present it is not possible for late registered users to be aware of a conference session and thus join the a conference, for which already invitations were issued.

In particular, this problem occurs in case potential participants of a conference were not registered to the network (e.g., are located in an area with no connectivity, or have their SIP device switched of).

Namely, in detail, a SIP User Agent creates a conference, and provides instructions to the conference server to dial-out a number of potential participants. The conference server sends an INVITE request to each of the potential participants, as described above. Out of those potential participants, some accept the invitation, and become participants of the conference. Others either reject the invitation (perhaps are busy), don't answer the call, are located in an area where there is no connectivity, or have the SIP device switched off.

Those potential participants that were logged into the network, but didn't accept/answer the call, will receive an indication of a missed call in their terminal's log, and thus, can join the conference at a later stage, if they wish. But the problem is that those potential participants that were not registered to the network (due to lack of coverage/connectivity, flat battery or phone switched off) will never be informed of the conference invitation. In case any of these potential participants become available (due to coverage/connectivity or phone switched on), they are not aware of the existence of the conference, and, thus, are not able to join the conference, if still is taking place.

The invitations for a session/conference may also include a unique session identifier (e.g., URI (Uniform Resource Identifier), SIP Call ID or similar) which is needed to join the session. The session identifier may be assigned per session basis (temporary identifiers). In this case, late registered users cannot know the session identifier which makes joining the session impossible even if they were aware of the session's existence.

### SUMMARY OF THE INVENTION

Hence, it is an object of the present invention to solve the problem mentioned above and enable users to join a group communication session which started when the user was not registered, not available, or the like.

This object is solved by a method for controlling group communication in a communication network. This method comprises the steps of sending, to a plurality of users, requests to join a group communication session, detecting that at least one of the users was not accepting the request to join the group communication, and subscribing to a status of the at least one of the users not joining the group communication session.

Alternatively, this object is also solved by a group communication server in a communication network, comprising means for sending, to a plurality of users, requests to join a group communication session, means for detecting that at least one of the users was not accepting the request to join the group communication, and means for subscribing to a status of the at least one of the users not joining the group communication session.

The status described above may be a registration status or a presence status, for example.

That is, after an unsuccessful invitation to a user to join a group communication session, a subscription is performed to the status (either the registration or the presence information) of this particular user. Hence, after registering of this user, or after the publication of the user's presence status, the sender (i.e., the group communication server) is notified of the registration or presence availability status and can send a further invitation to a group communication session.

Hence, in this way a user which registers after the invitation to a group communication session has already been issued (or was not available, is busy or does not answer etc.) can get knowledge of the existence of the group communication session, and can take part in the group communication session.

Thus, the group communication server (the conference server) may act as a watcher of the registration or presence information of a user, when the user is not connected to the network or not available.

Further advantageous developments are set out in the dependent claims.

### BRIEF DESCRIPTION OF THE DRAWINGS

The invention is described by referring to the enclosed drawings, in which:

FIG. 1 shows a network configuration comprising a conference server and a plurality of potential participants of a conference according to any of the embodiments of the invention,

FIG. 2 illustrates a message flow between the conference server and the SIP cores of the potential participants upon inviting to a conference according to a first embodiment,

FIG. 3 shows a message flow between the conference server, a late-registered participant and its SIP core after registering of this participant according to the first embodiment,

FIG. 4 shows a detecting procedure according to the first embodiment for detecting whether a user not responding to the conference invitation is registered or not,

FIG. 5 illustrates a message flow between the conference server and the SIP cores of the potential participants upon inviting to a conference according to a second embodiment,

FIG. 6 shows a message flow between the conference server, a late participant and its SIP core and presence server after this participant publishes his/her presence information, according to the second embodiment,

FIG. 7 shows a detecting procedure according to the second embodiment for detecting whether a user not responding to the conference invitation is available or not, and

FIG. 8 shows a message flow for handling a change of the S-CSCF of a non-registered user.

### DETAILED DESCRIPTION OF THE PREFERRED EMBODIMENTS

In the following, preferred embodiments of the present invention are described by referring to the attached drawings.

According to the first embodiment of the present invention, a mechanism for SIP core/network system is proposed, by which it is possible to send invitations to an existing group session for a user (participant) who performs registration to a SIP server at a later stage, i.e., when the conference session already exists and the user was not yet registered to SIP when the initiation procedure was performed.

Technically this is implemented such that a conference server (as an example for a group communication server) controls the existing and originally invited session, subscribing the registration information state of each of the invited users for which the conference server got a response indicating that he/she was not registered to the SIP core. In this case, once the late user registers to the SIP core, the controlling SIP server would get knowledge on that, and consequently would be able to send a new INVITE request also to this late registered user.

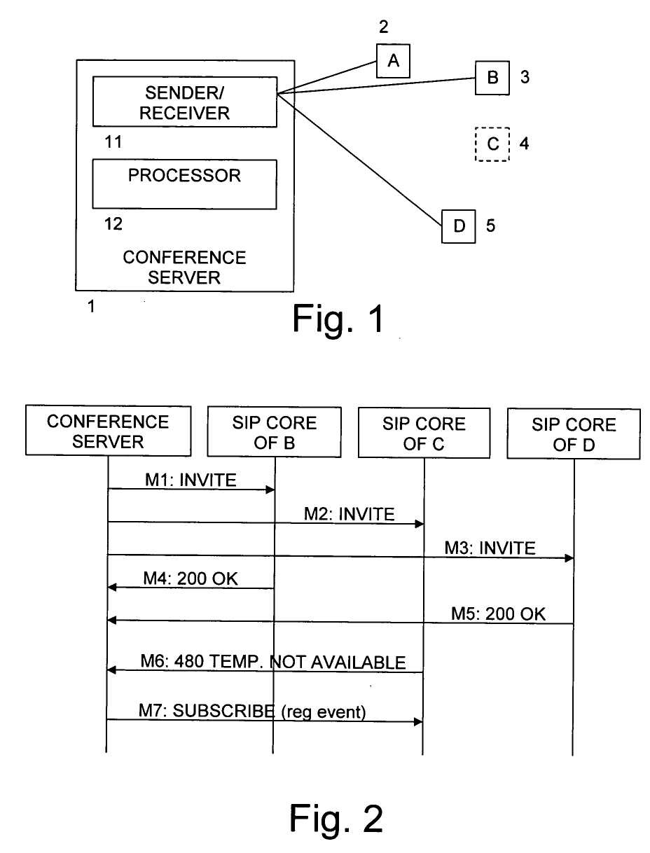

In the following, this procedure is described in more detail by referring to FIGS. 1 and 2.

FIG. 1 shows a network system illustrating the conference server 1, and a plurality of potential participants A to D (denoted with reference signs 2 to 5, respectively). The conference server comprises a sender/receiver 11 (as an example for a sending means) and a processor 12 performing several operations to be described later.

It is noted that the SIP core as used throughout the description is a network entity controlling SIP network of a participant (user) and typically comprises e.g. session control, routing, registrar and charging means/elements.

In this example, the following situation is assumed:

User A instructs the conference server 1 to initiate a group session to users B, C and D. Users B and D are registered to the SIP core at the time the conference server sends the invitation, and consequently, they are able to receive INVITE messages. Furthermore, they are able to join the session (conference).

User C is not registered to SIP core at the time the conference server sends the invitations to the users. This is illustrated in FIG. 1 by dashed lines, wherein no connection exists between the conference server and the user C (4). Due to the user C not being registered, his/her SIP core returns a final response for the INVITE that indicates that the user C is not registered (480 Temporarily Unavailable response in any SIP network, including 3GPP IMS (Internet Protocol Multimedia Subsystem)).

This is illustrated in the message flow diagram shown in FIG. 2. It is noted that in the message flow diagram of FIG. 2 and also in the other following message flow diagrams only those messages are illustrated which are helpful to explain the present invention, whereas other messages/procedures requiring for setting up the connection and the like are omitted for simplifying the description.

As shown, the conference server 1 sends INVITE messages M1, M2, and M3 to the users (the potential participants) B, C and D. It is noted that in FIG. 2 only the messages between the SIP core servers of B, C and D are shown, and the messages between the SIP core servers and the corresponding user terminals 3, 4 and 5 of the users B, C and D are omitted for simplifying the illustration.

As mentioned above, users B and D are registered, so 200 OK messages M4 and M5 are sent back to the conference server (assuming that the users B and D would like to participate in the conference). Since user C is not registered, the SIP core sends a 480 Temporarily Unavailable response M6 back to the conference server.

Once the conference server receives the response indicating a non-registered status (i.e., the 480 Temporarily Unavailable response), it subscribes to user's C registration status by sending a SUBSCRIBE request for the “reg” event (registration event) to the user's C SIP core of in message M7.

If the session ends before the user C registers, the conference server unsubscribes the reg event by sending a SUBSCRIBE request with the Expires header field set to zero.

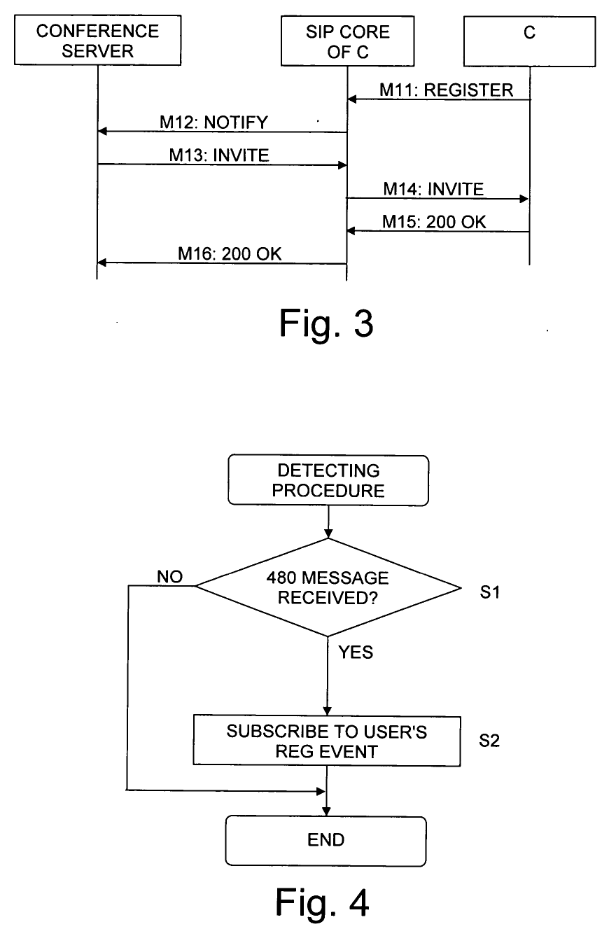

In the following, the situation when the user C registers and the conference has not ended yet is described by referring to FIG. 3, where also the messages between the SIP core server and the corresponding user terminal can be seen. When the user C registers by sending a REGISTER message M11 to its SIP core server, the SIP core of user C sends a NOTIFY message M12 containing the user's registration status to the conference server, thus it gets knowledge of the registration of the user C.

Once the conference server receives the notification, it invites the user C to the session by sending a further INVITE message M13 to the SIP core of user C. This is forwarded to the user C in message M14. In this example it is assumed that the user C would like to participate in the conference, so a 200 OK message M15 is sent to the SIP core, and is forwarded in message M16 to the conference server. Thus, the user C is informed of the existence (activity) of the conference and may join the conference.

The INVITE messages may also include a unique session identifier (e.g., URI, SIP Call ID or similar) which is needed to join the session (conference). The session identifier may be assigned per session basis (temporary identifiers). As described above, user C receives a further INVITE message M13, which includes the session identifier in this case. Hence, he gets the session identifier necessary to join the conference and can join it.

In FIG. 4, an example of a procedure for detecting the reason why a user does not accept the invitation is illustrated.

The procedure is carried out each time a response to an INVITE message is received. In step S1, it is checked whether a 480 Temporarily Unavailable response has been received. If this is not the case, no further detection is necessary, and the procedure ends.

If the user is not registered, so that a 480 Temporarily Unavailable response was received, the procedure proceeds to step S2, in which the subscription to the user's reg event status is performed (i.e., the message M7 shown in FIG. 2 is sent to the SIP core of user C).

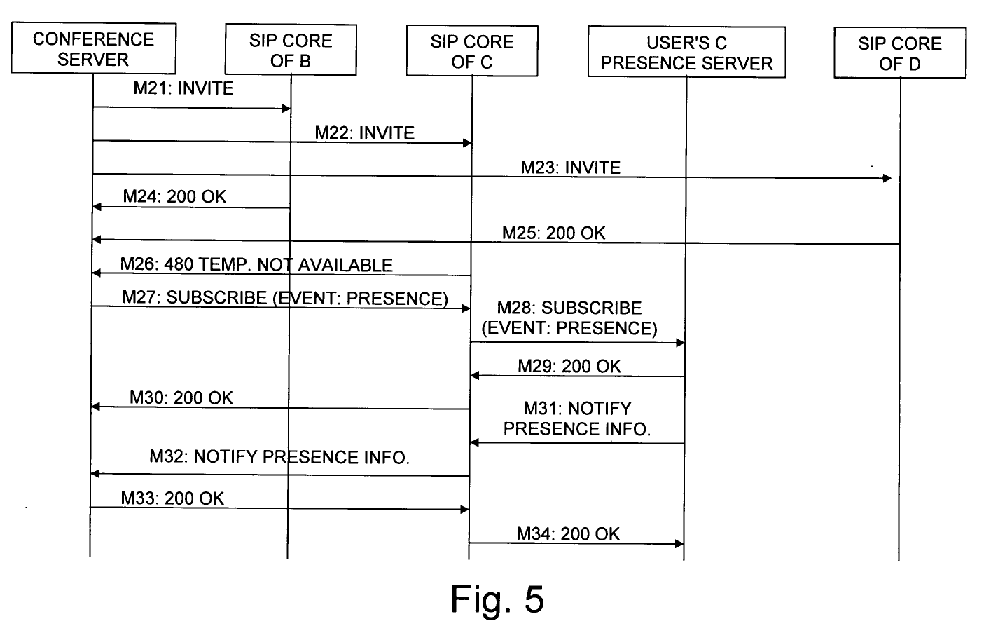

In a second embodiment described in the following by referring to the message flow diagram shown in FIG. 5, the situation is considered as an alternative to the first embodiment. That is, in contrast to the first embodiment, the conference server gets richer information of the availability of the user by subscribing to the presence status of those users that do not succeed in joining the conference. For instance, the conference server may get information that the user is away from his keyboard, busy, in a meeting, not registered, etc., and it will send a new invitation as soon as the user changes its presence information to available. Furthermore, the conference server may get from the presence information an indication of an alternative way to reach the intended user (e.g. reachable via another address) or another contact person that is able to attend the conference (e.g., a secretary or a member of the family).

According to FIG. 5, the conference server sends INVITE messages M21, M22, and M23 to the users (the potential participants) B, C and D. B and D are registered and joining the conference, so 200 OK messages M24 and M25 (similar to messages M4 and M5 shown in FIG. 2) are sent back to the conference server. Since user C is not registered, the SIP core sends a 480 Temporarily Unavailable response M26 (corresponding to message M6 shown in FIG. 2) back to the conference server, similar as described in connection with the first embodiment.

Once the conference server receives the response indicating a non successful result (i.e., any 400-class, 500-class or 600-class response) or the user does not answer and the INVITE request times out, it subscribes to user's C presence information status by sending a SUBSCRIBE request for the presence event to user's C SIP core in message M27. User's SIP core will further route the message M28 to user's C presence server. This is acknowledged by the user's C presence server by sending a 200 OK message M29 to the SIP core of C, which forwards this 200 OK message to the conference server in message M30.

User's C presence server will send a NOTIFY request containing presence information in message M31, which is received by the conference server (message M32). This is acknowledged by the conference server by sending an 200 OK message via the SIP core of C to user's C presence server (messages M33 and M34). At this point in time, the conference server is able to determine if there are alternative ways to reach the user or alternative contacts (e.g., a secretary or a member of the family) for user C, in which case the conference server may immediately send a new INVITE to this alternative contact.

If the session ends before the user C changes its presence information to available, the conference server unsubscribes the presence information event by sending a SUBSCRIBE request with the Expires header field set to zero.

It must be noted that if the presence information of the user reveals that he is registered to the SIP core, but not available (e.g., he is away from his SIP device), then the conference server may send periodic INVITE requests to such user, in case the alerting tone at user's C terminal brings the user's attention, and he may join the conference.

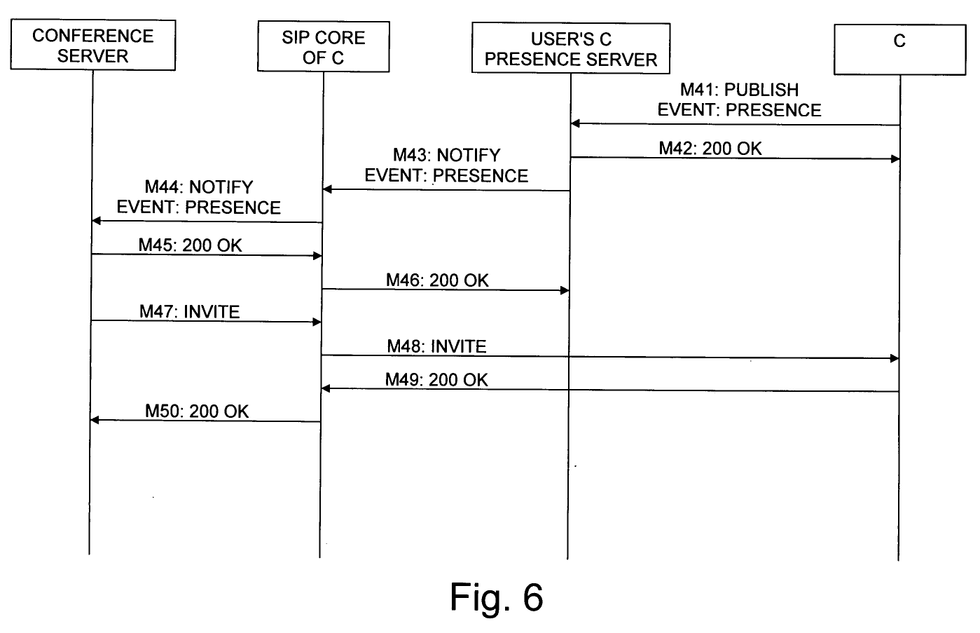

In the following, the situation when the user C changes its presence information and the conference has not ended yet is described by referring to FIG. 6. It is worth noting that in the following description it is assumed that the user C publishes his own presence information (by sending a PUBLISH request), but this need not be the case. Any authorized entity that has gotten user's C presence information can publish it. For instance, a SIP registrar (such a S-CSCF in 3GPP IMS) can publish user's C presence information upon registration of user C.

According to FIG. 6, the user C sends a PUBLISH request M41 to indicate a change in his presence information, such as, the user is available now. This request is received by user's C presence server (acknowledging this with the 200 OK message M42), which sends a NOTIFY request M43 to all the subscribed parties, among others, the conference server. This NOTIFY request contains the change in user's C presence information. The SIP core routes the message to the conference server (M44). The NOTIFY request is acknowledged by the 200 OK messages M45 and M46 sent to the SIP core of C and from there to user's C presence server. The conference server analyzes the presence information, and since user C is now available, and since (in this example) the conference is still going on, sends a new INVITE request M47 to user C. This message is routed through the SIP core and eventually delivered to user C (M48), who gets knowledge of the existing conference and can join it (wherein C acknowledges the INVITE request by sending a 200 OK message M49 to the SIP core C, which forwards it to the conference server in message M50).

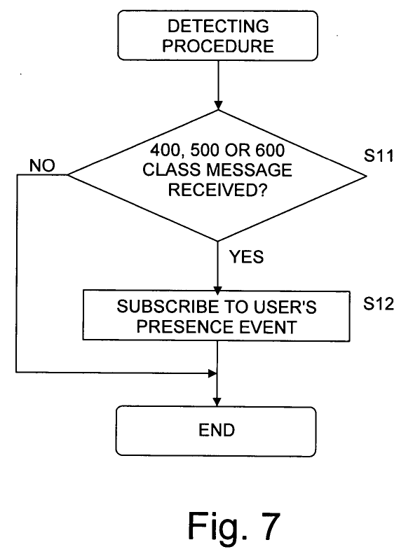

FIG. 7 shows an example of the detection procedure illustrated, similar as that shown in FIG. 4 in connection with the first embodiment.

The procedure is carried out each time a reaction to an INVITE message is received. In step S11, it is checked whether a 400, 500, or 600-class response has been received. If this is not the case, no further detection is necessary, and the procedure ends.

However, if a 400-, 500-, or 600-class response is received, then the procedure proceeds to step S12, in which the conference server subscribes to the user's presence information. Alternatively, the conference server may subscribe to the user's presence information only when certain predefined responses are received.

It is noted that it is not necessary to trigger the subscription on any 400-, 500- or 600-class response. That is, the conference server may comprise a predefined set (or list) of responses which trigger the subscription. This set of responses may be a subset of the 400-, 500- and 600-class responses, and/or may contain also other suitable responses.

Furthermore, as described above, instead of detecting the 400-, 500- or 600-class response, alternatively also a timer can be used. That is, if the timer times out after sending the INVITE request, then the conference server may subscribe to the user's presence information.

As described above, when the conference server does not receive a positive answer (200 OK) from any of the potential participants, the conference server subscribes to the presence state of such potential participant. The presence subscription will inform user's availability to the conference server when the availability information changes. According to the first or the second embodiment, the conference server can send a periodic invitation (e.g., every 15 minutes), if the user is online. If the user is offline, the conference server can send an invitation when the user becomes online and publishes his online status.

The conference server sends an INVITE request to each of the potential participants. If a potential participant accepts the session (e.g., answers with a 200 OK response), then the conference server inserts it as a participant in the conference, and no further actions are needed.

If a potential participant does not become a participant (rejects the session, does not answer, is not registered, etc.), the conference server may subscribe to the potential participant presence information by sending a SUBSCRIBE request with the Event header field set to presence.

With respect to first embodiment, the following is noted with respect to de-registering of the user. In detail, when the user de-registers, his S-CSCF (Serving Call Session Control Function) allocation is released. Once the terminating request (here SUBSCRIBE) is received by the IMS and the user is unregistered, the IMS may allocate a new S-CSCF to perform user's services. IMS should allocate the S-CSCF if the user has services that need to be performed for unregistered user. Once the user registers, the IMS again allocates a new S-CSCF to perform the services for registered user. This means the S-CSCF which received the SUBSCRIBE for reg event may be different from the one that receives the user registration indication, thus the IMS is not able to send NOTIFY for reg event back to the reg event subscriber.

This problem may be solved in the following way. Reg event subscriptions will be routed to dedicated Application Server (AS). This can be achieved by using iFC (initial Filter Criteria) in the S-CSCF. Also user registrations and de-registrations are routed to the same AS. Also this can be achieved by using iFC (this is so called 3^{rd} party registration, IMS registers to the AS on behalf of the user). This means the AS that receives the reg event subscriptions is aware of the user registration status, and thus is able to send NOTIFY for reg event.

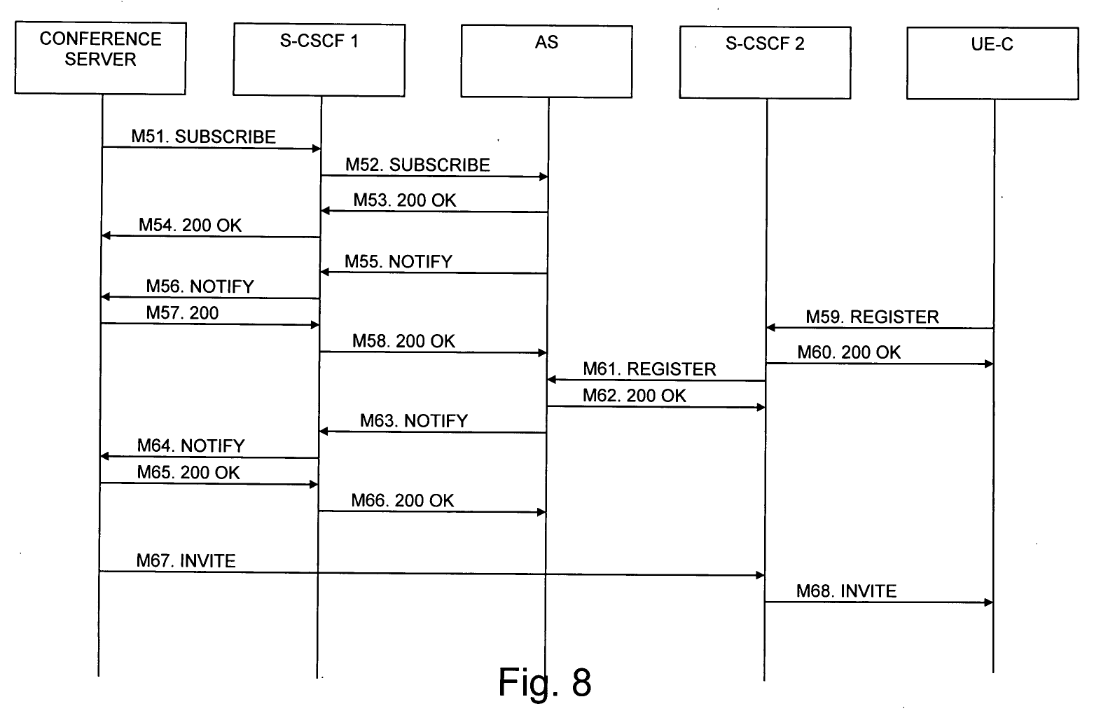

This is shown in FIG. 8. As shown, the subscription is performed by message M52 with the AS. The SUBSCRIBE is routed to AS via S-CSCF of user C, after the conference server has sent message M51: SUBSCRIBE (reg event) to the present S-CSCF 1 of user C. The subscription is confirmed via 200 OK messages M53 to M54. The AS responds with the current registration status of the User C (here unregistered), that is messages M55-M56 (NOTIFY) in FIG. 8. This is confirmed via 200 OK messages M57 to M58. Thus, after user C registers by sending a REGISTER message M59 to its S-CSCF (which may now be a different S-CSCF than the one via which the SUBSCRIBE was routed in previous step), the S-CSCF (in this case, S-CSCF 2, i.e., a different S-CSCF) performs a third party registration to the AS and sends a REGISTER message M61 to the dedicated Application Server. The REGISTER messages M59 and M61 are confirmed by 200 OK messages M60 and M62, respectively.

The application server sends a NOTIFY message to the conference server in messages M63-M64, indicating user C's registration status (here registered), which are confirmed by 200 OK messages M65 and M66. After this, the conference server sends an INVITE message M67 towards the user C (via S-CSCF 2 and message M68). In case user C accepts, a 200 OK message is sent back to the conference server (this message is not shown in the figure).

In case of OMA (Open Mobile Alliance) PoC (Push-to-talk over Cellular) service and 3GPP IMS, the dedicated AS mentioned above is user's participating PoC server. The reg event subscription is sent from controlling PoC server. These two PoC servers can be located in different domains, since there is NNI (Network-to-Network Interface) in place between the domains, and both domains are trusted, so the subscribed domain can trust to send the NOTIFY to the subscribing domain.

The invention allows the maximum participation of potential participants in a conference. For the operator, it creates the maximum revenue, since it maximizes the participation of users in conferences.

As mentioned above, the invention can be used in PoC environments, because a PoC group is just a conference. It can also be used in 3GPP IMS or any other SIP network that provides conference services based on SIP.

The invention is not limited to the embodiments described above, and various modifications are possible.

1. A method for controlling group communication in a communication network, the method comprising the steps of:
sending, to a plurality of users, requests to join a group communication session,
detecting that at least one user of the plurality of users was not accepting a request to join the group communication session, and
subscribing to a status of the at least one user of the plurality of users not joining the group communication session.

2. The method as claimed in claim 1, wherein the subscribing step comprises subscribing to a registration status of the at least one user.

3. The method as claimed in claim 1, wherein the subscribing step comprises subscribing to a presence status of the at least one user.

4. The method as claimed in claim 1, further comprising the step of
receiving a response to a subscription, wherein the response indicates activity of the at least one user.

5. The method as claimed in claim 4, wherein the activity of the at least one user comprises an indication the at least one user has registered to a network.

6. The method as claimed in claim 4, further comprising the step of
sending to the at least one user another request to join the group communication session, after receiving the response indicating the activity of the at least one user.

7. The method as claimed in claim 2, further comprising the step of
detecting a reason why the at least one user was not accepting the request, wherein a subscription to said status is made if the reason indicates that the at least one user is not registered to a network.

8. The method as claimed in claim 7, wherein the detecting a reason step comprises:
determining that the at least one user is not registered to the network based on a reception of a particular message related to the at least one user.

9. The method as claimed in claim 8, wherein the particular message related to the at least one user comprises a 480 temporarily unavailable response of Session Initiation Protocol (SIP).

10. The method as claimed in claim 3, further comprising the step of
detecting a reason why the at least one user was not accepting the request, wherein a subscription to status is made if the reason indicates that the at least one user is not present in a network.

11. The method as claimed in claim 10, wherein the detecting a reason step comprises determining that the at least one user is not present in the network based on a reception of a particular message related to the at least one user.

12. The method as claimed in claim 11, wherein the particular message comprises one of a predefined set of responses.

13. The method as claimed in claim 12, wherein the predefined set includes at least a part of 400, 500 or 600 class responses.

14. The method as claimed in claim 1, wherein the subscribing step comprises routing a subscription to a dedicated application server.

15. The method as claimed in claim 6, further comprising the step of repeating the sending of the another request to join a group communication.

16. The method as claimed in claim 1, further comprising un-subscribing to the status of the at least one user of the plurality of users when detecting one of the group communication session is ended or said at least one user has successfully joined the group communication session.

17. A group communication server in a communication network, the server comprising:
first sending means for sending, to a plurality of users, requests to join a group communication session,
first detecting means for detecting that at least one user of the plurality of users was not accepting a request to join the group communication session, and
subscribing means for subscribing to a status of the at least one user of the plurality of users not joining the group communication session.

18. The group communication server as claimed in claim 17, wherein the status comprises a registration status of the at least one user.

19. The group communication server as claimed in claim 17, wherein the status comprises a presence status of the at least one user.

20. The group communication server as claimed in claim 17, further comprising
receiving means for receiving a response to a subscription, wherein the response indicates activity of the at least one user.

21. The group communication server as claimed in claim 20, wherein the activity of the at least one user comprises an indication the at least one user has registered to a network.

22. The group communication server as claimed in claim 20, further comprising
second sending means for sending to the at least one user another request to join the group communication session, after receiving the response indicating the activity of the at least one user.

23. The group communication server as claimed in claim 18, further comprising
second detecting means for detecting a reason why the at least one user was not accepting the request, wherein the subscribing means is configured to subscribe to the status if the reason indicates that the at least one user is not registered to a network.

24. The group communication server as claimed in claim 23, wherein the second detecting means is configured to determine that the at least one user is not registered to the network based on a reception of a particular message related to the at least one user.

25. The group communication server as claimed in claim 24, wherein the particular message related to the at least one user comprises a 480 temporarily unavailable response of session initiation protocol (SIP).

26. The group communication server as claimed in claim 19, further comprising
second detecting means for detecting a reason why the at least one user was not accepting the request, wherein the subscribing means is configured to subscribe to the status if the reason indicates that the at least one user is not present in a network.

27. The group communication server as claimed in claim 26, wherein the second detecting means is configured to determine that the at least one user is not present in the network based on a reception of a particular message related to the at least one user.

28. The group communication server as claimed in claim 26, further comprising storing means for storing a predefined set of responses, wherein a particular message related to the at least one user is a response of the predefined set of responses.

29. The group communication server as claimed in claim 28, wherein the predefined set includes at least a part of 400, 500 or 600 class responses.

30. The group communication server as claimed in claim 17, further comprising repeating means for repeating sending of another request to join the group communication session.

31. The group communication server as claimed in claim 17, further comprising un-subscribing means for un-subscribing to the status of the at least one user of the plurality of users when detecting that one of the group communication session is ended or that said at least one user has successfully joined the group communication session.

32. A computer program embodied on a computer-readable medium, said computer program configured to control a computer to perform the steps of:
sending, to a plurality of users, requests to join a group communication session;
detecting that at least one user of the plurality of users was not accepting a request to join the group communication session; and
subscribing to a status of the at least one user of the plurality of users not joining the group communication session.
